(19) United States
(12) Patent Application Publication
(10) Pub. No.: US 2003/0023717 A1
(43) Pub. Date: Jan. 30, 2003

(54) Method and apparatus to reveal the usability of an internet web site

(76) Inventor: Michael L. Lister, London (GB)

Correspondence Address: Michael S. Neustel, Suite No. 4, 2534 South University Drive, Fargo, ND, 58103, US

(21) Appl. No.: 09/916,730

(22) Filed: Jul. 26, 2001

(51) Int. Cl. G06F 15/173

(52) U.S. Cl. 709/224

(57) ABSTRACT

A method and apparatus are disclosed to reveal the experience of the Web browser while connecting and transacting with an Internet Web site. A proxy server module is provided to transparently detect passing bi-directional data between the Web server and Web browser and has the additional capability to selectively adjust the Internet link bandwidth and latency to simulate other link environments commonly encountered by the Web browser. The captured data from a user session, including the target server response time, total bytes transceived, and the Request/Response header object, are provided to properly characterize the performance of the end user link, web server and the usability of the Web site.

### BACKGROUND OF THE INVENTION

1. Field of the Invention

The present invention relates generally to Internet telecommunication performance. More specifically, the present invention provides a method and apparatus to characterize the usability of a Web site for the Web browser.

2. Description of the Prior Art

In 1992, the National Science Foundation (NSF) announced that the funding and control of the NSFNET backbone (national high speed data links) would be phased out and commercial entities were encouraged to set up private backbones (owned or leased telephone high speed trunk lines to carry large amounts of data nationally) since the original infrastructure, rooted in academic and military purposes, did not permit the transport of commercial data. In 1995, the NSF handed over the original four Network Access Points (NAPs), or exchange points between network backbone providers, to private telecommunication companies. Shortly thereafter, the Internet expanded beyond universities and scientific sites to include businesses and individual users connecting through commercial backbone providers as well as other smaller Internet Service Providers (ISPs) and other types of online services. Since the termination of federal funding for the NSFNET backbone, the Internet has evolved with backbone/service providers offering greater bandwidth capacity in an attempt to handle the ever-increasing user traffic load.

FIG. 1 is a simplified representation of the Internet 100 of a non-limiting preferred example environment to implement the inventive concept. As is well known, the Internet consists of tens of thousands of interconnected data networks worldwide, all of which use the Internet protocol (IP). Three basic types of entities are identified as the clients or end users, Internet Service Providers (ISPs) 104 & 106 and/or backbone providers 105 & 107). End users access and send information either through individual connections 101 & 108), organizations 103 & 109 such as universities and businesses 103 and business, groups or individuals that maintain Web sites on a network server 113. The ISPs such as AT&T, MCI and America Online connect their subscribers to the Internet over their own backbone networks, routers 110 and regional links 111. The backbones of these providers meet at Network Access Points (NAPs) 112 where they exchange traffic with each other as well as with many other smaller backbone providers. Since the Internet has no central access point, ISPs maintain multiple points of interconnection such that individual transmissions may be routed through multiple service providers to get data to its destination.

It is estimated that as many as half a billion people worldwide will be Internet users by year-end 2001. Today, Internet users routinely Web browse for information, shopping or for simple entertainment. Electronic mail services are very popular since they provide an easy and inexpensive method to move text, images and audio around the world from one user directly to another without the time delay and packaging handling of the Post Office or other mail handler. In addition to these and other well-known services, ISPs are offering an increasing number of new access services that include Web TV, Internet capable video game stations for consumers, and content access through cellular telephones and personal digital assistants. This explosive growth in handy products and ready users has inevitably created congestion points on the Internet. Users that Web browse are understandably frustrated with delays that are generally attributed to rush-hour congestion, slow communication or unavailable (dial-up) access to the local ISP and Web sites that have problems; unavailable elements, useless areas, poor navigation aids, dead end paths or generally not user friendly.

The end users have options to combat connection and download delays. The end users may choose to upgrade to faster hardware, install the better or efficient browser (i.e. Internet Explorer, Netscape Navigator or Lynx) or invest in a network connection with more bandwidth. An upgrade to any ISP offered broadband line such as a Digital Subscriber Line (DSL), Integrated Services Digital Network (ISDN), ground or satellite based wireless systems or an expensive dedicated T1 line. Inexpensive solutions to the user include the practice to clear the browser cache, multitask while on the Internet and avoid the parts of the day common to Web rush-hour congestion.

However, users have little control over the ISP managed portion of the network or the Web server at the “other end” of the Internet connection. The speed in which an Internet user request/response is completed is essentially dependent on the capability of the end user equipment and the link bandwidth between the users managed by the ISP. The ISP managed backbone does not usually impact connection delays since the ISP utilizes high speed optical fiber cable, line data rates of 50 Mbps to 13 GBPS and dynamic routers to minimize latency. Dynamic routers have the ability to reconfigure the routing table automatically and recalculate the most efficient path in terms of load, line delay or bandwidth to reliably move data across the Web.

The “other end” to an Internet browser is usually a Web server 112, physically located anywhere in the world, connected to the Web with any chosen locally offered line rate and running software based client websites that offer all manner of information, products and services. Any properly configured personal computer can serve as a Web server. The Web does not have central control but a general agreement between vendors to use a collection of designated practices policies and procedures or protocols. The governing two protocols are Transmission Control Protocol and Internet Protocol (TCP/IP). Consequently, Web browsers experience a wide variety of information and connectivity conditions.

Users that surf the net (Web browsers) often discontinue access attempts or transactions with inoperable or annoying Web sites and search for the information or product elsewhere (on a different web server and/or website). Companies that advertise on the Internet realize that a pleasurable user experience is necessary for higher activity or sales. Today, the user expects a Web site to contain rich graphics, easy navigation, accurate and easy to find information and a fast and reliable connection.

What is needed is an approach to provide statistical information of the Web site browser experience to the Web site administrator such that all aspects of the Web site and supporting equipment can be adjusted to best advantage.

### SUMMARY OF THE INVENTION

The present invention relates to a method and apparatus to provide the Web site administrator a tool to capture and statistically assess the full Internet Web site browser experience. A Proxy Server Module provides a ‘wedge’ that fits in between a client application and the connection with the Internet based Web server, selectively simulating bandwidth and latency of slower connections and gathering statistics and information on the requests for access and transactions made and received. The Proxy Server provides this as transparently as possible, deliberately not providing the advanced services other industry standard proxies provide, such as caching, so as to simulate more accurately a direct connection to the Web server.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a prior art diagram of an exemplary Internet structure.

FIG. 2 shows a block diagram of an embodiment of the invention applied to a single workstation.

FIG. 3 shows a system block diagram of other embodiments of the invention utilized in a legacy network.

FIG. 4 represents the functional elements of the Proxy Server Module.

### DESCRIPTION OF THE PREFERRED EMBODIMENT

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital video discs), and computer instruction signals embodied in a transmission medium (with or without a carrier wave upon which the signals are modulated). For example, the transmission medium may include a communications network, such as the Internet.

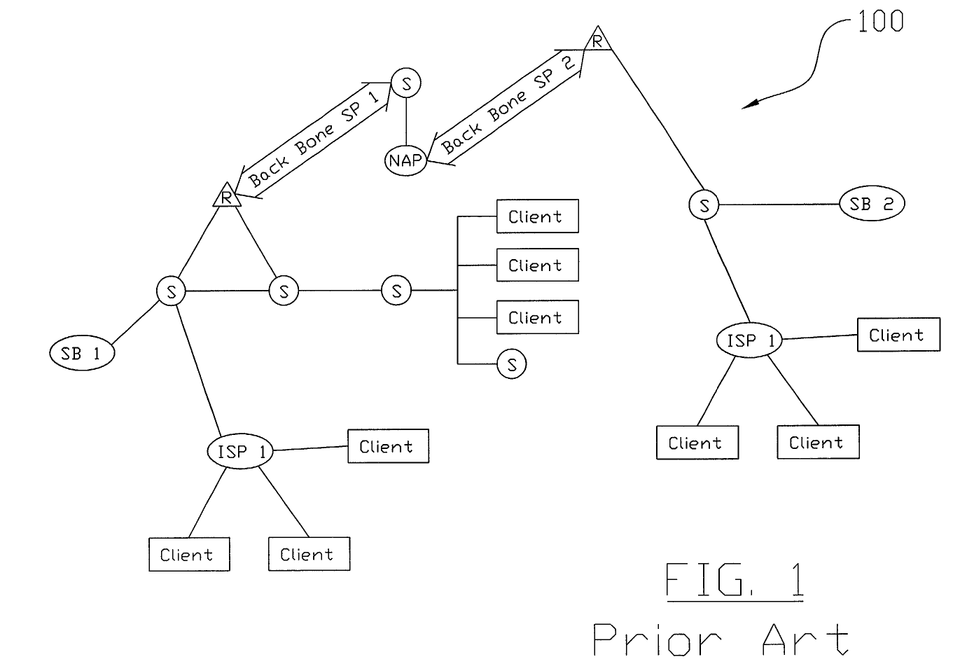

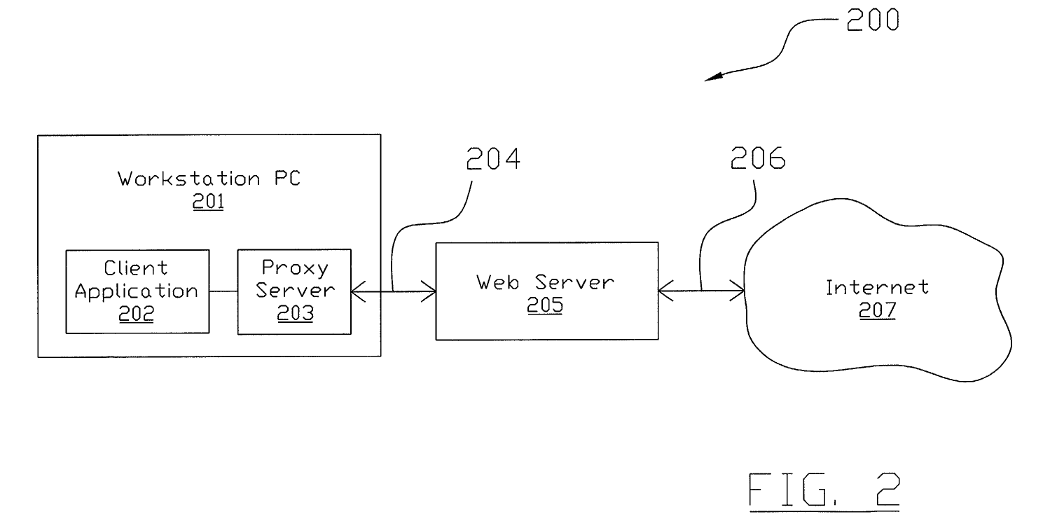

FIG. 2 shows the preferred embodiment 200 of the inventive concept in relationship to the Internet 100 as described for FIG. 1. A client Workstation PC 201 is shown preferably realized as the well known Personal Computer, easily configured in software and hardware for the intended application. The Workstation PC of FIG. 2 includes, but is not limited to a Pentium processor running at 120 MHz or faster, 32 MB RAM, a multifunction network interface card (NIC) with 56 kbps FAX/Modem and 10Base-T Ethernet adapter (10 Mbps), a CD-ROM drive at double-speed (2×) or faster, sufficient ROM and hard drive for temporary and permanent data storage, serial and parallel ports, monitor, keyboard, mouse and loaded with the client application software 202. The client application includes browser software such as Microsoft's Internet explorer or Netscape Navigator running under the Windows 2000, Windows NT or the equivalent operating system to provide the end user interface and protocol compatibility to a server 205 that in turn provides access to a LAN or Wide Area Network (WAN). For the Internet application of the Proxy Server, the server would correspond to a Web server and the WAN 207, the Internet. The connection links of FIG. 2 204 & 206 are preferably Ethernet or USB broadband connections between the Workstation PC and Web Server and a DSL (640 Kbps to 7.1 Mbps) or a quality T-carrier (T1 @ 1.54 Mbps) between the Web Server and the Internet Service Provider. A basic 56 Kbps rate modem or 64 Kbps ISDN type connections are applicable but due to the lower line rate, would not fully utilize the advantages of the invention.

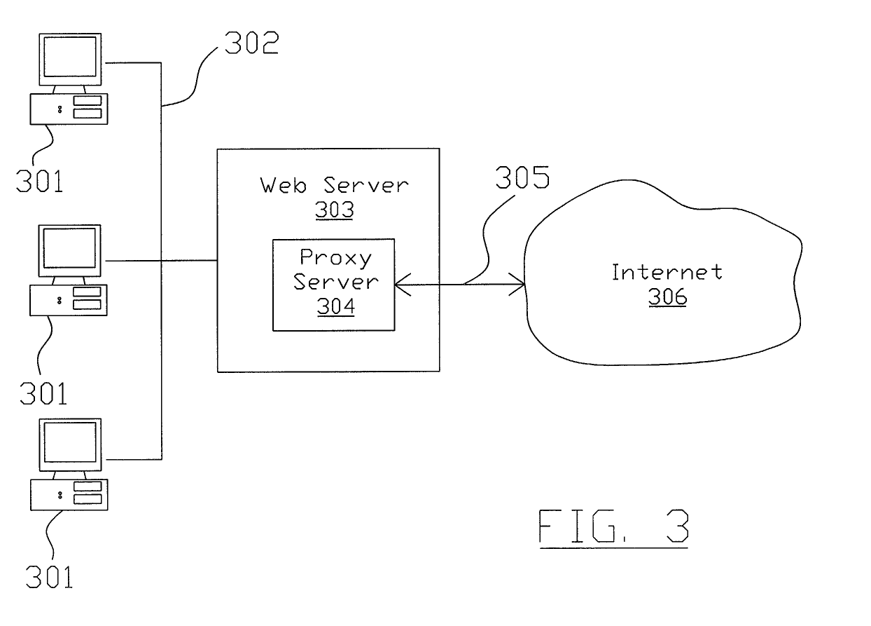

In the preferred embodiment of FIG. 2, the Proxy Server Module is loaded onto the Windows 2000 based client Workstation PC 201. The browser Services File of the client PC is configured to route the selected service applications through selected proxy ports to the Proxy Server 203 in accordance with the protocol standards of TCP/IP. The Proxy Server Module 203 is configured to “listen” for the selected service applications on the proxy ports, capture the desired data and route the selected service applications through the standard service ports across link 204 to the Web server 205. This application of the Proxy Server Module, as opposed to firewall applications and the like, performs this function transparently. The selected data is not cached or otherwise manipulated to avoid any delay or latency in the throughput of the outgoing or incoming data. The standard or well known service ports are assigned a port ID number defined by the Internet Corporation for Assigned Names and Numbers (ICANN) to insure network connectivity under the TCP/IP protocol. The network of FIG. 3 can be configured to use a non-standard port ID number for the proxy ports as in the connection between the workstation PC and Proxy Server Module.

FIG. 3 shows a second embodiment of the invention 300 where the Proxy Server Module 304 is loaded onto the computer platform of the Web server 303. The Proxy Server Module can alternatively be loaded on a gateway instead of the Web server of FIG. 3 where it provides an Internet connection and access to any internet based Web server. Several Workstation PC(s) 301 are connected in a Local Area Network 302 to communicate over small geographical areas such as in a home office, one wing of a building, several buildings on a small campus or other small building. The LAN can run over various network architectures such as Ethernet and token ring. Both architectures employ high data rates, commonly 4 to 100 Mbps depending on the selected version.

In the LAN configuration, the proxy ports ID of the individual Workstation PCs are configured as in FIG. 2 but would also be assigned individual IP addresses in accordance with IP protocol. This enables the Proxy Server Module to recognize the individual selected service applications from the individual workstations for complete statistical analysis. Since TCP/IP protocol defines the transmission and addressing of end user data across the WAN, other user based networks other than the LAN 103 & 302 are equally applicable to utilize the Proxy Server Module.

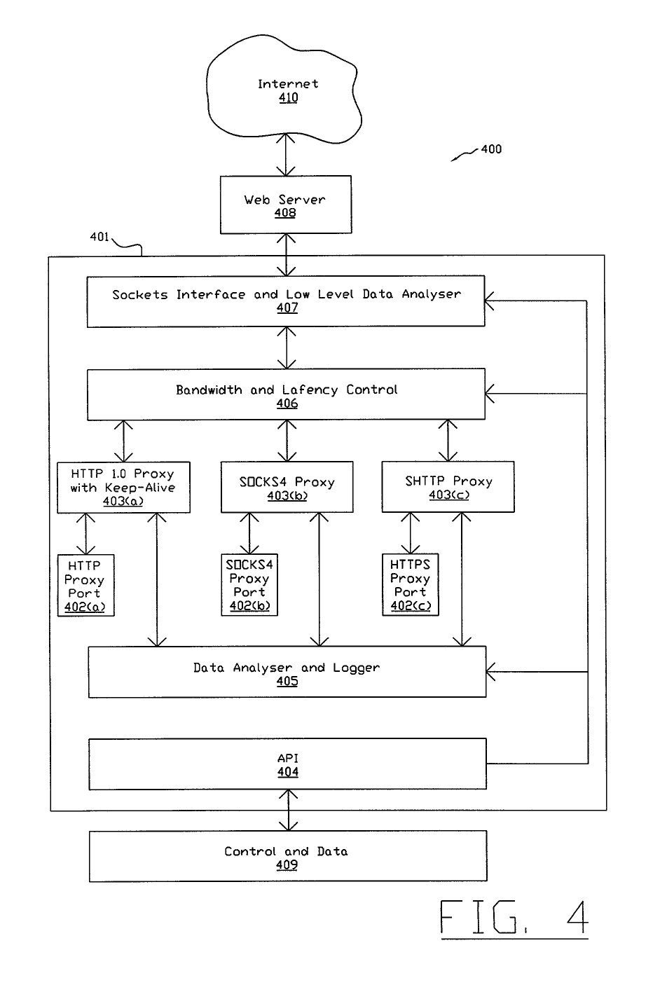

FIG. 4 illustrates the functional elements of the Proxy Server Module 401. The Proxy Server Module is packaged as a Windows DLL (Dynamic Linked Library) and provides the Application Programming Interface (API) 404 through a set of C Language style functions. A C++ Language class interface exists under this allowing more intermit control and static linking to the library. The API enables the main application to be built around inexpensive PCs. The Proxy Server Module is ported 403 to monitor and examine the Request and Response header objects of three types of application services, each with a different application level protocol; Hypertext Transfer Protocol (HTTP) Proxy Server, SOCKS4 Proxy and Secure Hypertext Transfer Protocol (HTTPS) Proxy. These sub-systems provide “listening ports” on the local system. The Web browser proxy settings on the Workstation PC(s) are configured to point to these ports to effectively pass all data through the Proxy Server Module. The main application 409 accesses the proxy monitors 403, the Data Analyzer 405, Logger 402, Bandwidth and Latency Control 406 and the Sockets Interface and Low Level Data Analyzer 407 through the DLL that translates function calls with the Application Interface (API) 404.

The HTTP Proxy Server implements the HTTP 1.0 standard with the industry evolved Keep-Alive standard. This sub-system passes through requests from the Web browser to the Web servers with very little modification and attempts where possible to simulate the nuances and subtleties of the Web browser communications to give an experience as near as possible to a directly connected user session.

The SOCKS4 protocol provides an application protocol independent connection to external servers. It is used to “mop up” all the application level protocols that a Web browser session may require such as File Transfer Protocol (FTP), Gopher and HTTPS. The information gathered from protocols through SOCKS4 is limited and consists of data throughput related statistics. The main application of the SOCKS4 data streams is to be applied through the bandwidth and latency constraints 406.

The HTTPS Proxy protocol is a secure version of HTTP that encrypts sensitive data such as credit card transactions. Due to the nature of this protocol, throughput information can not be extracted from the Request/Response header. Browsers can be configured to tunnel this protocol through SOCKS4 but and HTTPS Proxy monitor is included so that the data throughput and statistics can be attributed for this protocol.

The Bandwidth and Latency Control 406 sub-system is provided to simulate slower connections. The main application selectively introduces a latency parameter to simulate an added latency or delay introduced to the network connection by the end user particular equipment including a modem or terminal adapter. The main application also selectively introduces a bandwidth parameter to simulate the bandwidth, or in other terms, the data rate of the end user's equipment to link the client application to the Web server (ISP). The network administrator may replace default parameter values with pre-stored pre-characterized tabularized values or input custom values prior to or during operation of the Proxy Server Module. Characterized modems include the “dial-up” variety utilized by the typical home user and corporate LAN system modems. Terminal adapters used in leading broadband technologies are also characterized and include cable line (TV), Integrated Services Digital Network (ISDN), Digital Subscriber Line (DSL) and satellite or ground wireless services.

The Data Analyzer 405 detects performance parameters extracted as request and response application service header objects. These header objects provide the detailed information on what the Web browser is requesting/receiving, the Web site interaction data.

The Low Level Data Analyzer 407 detects the access and connection performance parameters. The performance parameters include, but are not limited to, the target server response, the transmit and receive pre-delay, total bytes transmitted/received, total transmit/receive delay, total time. For example, the target server response time includes the time for the Web server to complete a full page download from the Web site and total time includes the length of time the Web browser spends on the Web site.

The Logger 402 associates and records the information detected in the Data Analyzer and Low Level Analyzer to build the statistics on the complete user experience. The Logger logs the data to be asynchronously queued ready for examination through the API by the main application. Three separate queues are held, one for each proxy sub-system.

The client Workstation PC is provided with a graphical, text or other suitable interface to the Proxy Server main application to access the statistical data and selection of the bandwidth and latency parameters, performance parameters and proxy/network port configuration. The Proxy Server main application may be based on the Java programming language to enable network administrators with the correct access codes to access the main application at any remote network terminal. The network administrator may be the client, network manager, application developer or other authorized personnel.

The Proxy Server provides a powerful tool for the Web site server administrator to identify the Web site experience of the Web browser. During a user session, the Proxy Server transparently gathers and analyses the connection performance, object selection within the Web site and provides selective bandwidth and latency control over the connection to simulate the connection environment to provide the full picture of the user experience.

As to a further discussion of the manner of usage and operation of the present invention, the same should be apparent from the above description. Accordingly, no further discussion relating to the manner of usage and operation will be provided.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. Additionally, the above disclosure is not intended to limit the invention. The scope of the invention is defined by the appended claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method for a proxy server module to monitor and gather statistical information on the communication traffic between a client workstation and a telecommunication network comprising the steps of:
configuring the client application of the client workstation to route selected application services through selected proxy ports;
receiving the selected application services at the selected proxy ports;
analyzing performance parameters from the received application services at the selected proxy ports;
logging the analyzed performance parameters to build statistics;
transmitting asynchronously the statistics to a network administrator;
transferring the bi-directional selected application services between the proxy ports and other network ports; and
connecting the selected application services at the network ports to a WAN node.

2. The method as recited in claim 1, wherein said client workstation is a personal computer configured for the client application.

3. The method as recited in claim 2, wherein said client application is a Web browser.

4. The method as recited in claim 3, wherein the Web browser is any one of Microsoft Internet Explorer or Netscape Navigator.

5. The method as recited in claim 4, wherein the selected application services comprises HTTP, HTTPS and SOCKS4 application level protocols.

6. The method as recited in claim 5, wherein said selected proxy ports are selected unused identification ports selected by the network administrator and governed by TCP/IP protocol.

7. The method as recited in claim 5, wherein said performance parameters comprises the target server response time, the transmit and receive pre-delay, total bytes transmitted/received, total transmit/receive delay, total time and the Request/Response header object.

8. The method as recited in claim 1, wherein said proxy server is essentially transparent to the network.

9. The method as recited in claim 1, wherein said transferring comprises transferring the selected application services between said proxy ports and assigned standard network ports governed by TCP/IP.

10. The method as recited in claim 1, wherein said step of transferring comprises transferring the selected application services between proxy ports and other network ports via bandwidth and latency control.

11. The method as recited in claim 10, wherein the network administrator access comprises:
bandwidth and latency adjustment of the selected application services
proxy and network port selection;
performance parameter selection;
proxy server module application changes; and
statistical results.

12. The method as recited in claim 11, where the network administrator is provided access at said client workstation or from a remote terminal connected to the network.

13. The method as recited in claim 1, wherein said WAN node is a network server.

14. The method as recited in claim 1, where the said WAN node is an Internet Web server.

15. A computer program of a proxy server module embodied on a computer readable medium to monitor and gather statistical information on the communication traffic between a client workstation and a telecommunication network comprising:
a code segment to configure the client application of the client workstation to route selected application services through selected proxy ports;
a code segment to analyze performance parameters from the received application services at the selected proxy ports;
a code segment to log the detected performance parameters;
a code segment to asynchronously transmit the statistics to a network administrator;
a code segment to transfer the bidirectional selected application services between the proxy ports and other network ports; and
a code segment to enable the selected application services at the network ports to connect to a WAN node.

16. A computer program as recited in claim 15, wherein the client workstation is a personal computer configured for the client application.

17. A computer program as recited in claim 16, wherein the client application is a Web browser.

18. A computer program as recited in claim 17, wherein the Web browser is any one of Microsoft Internet Explorer or Netscape Navigator.

19. A computer program as recited in claim 18, wherein the selected application services comprises HTTP, HTTPS and SockS4 application level protocols.

20. A computer program as recited in claim 19, wherein said selected proxy ports are selected unused identification ports selected by the network administrator and governed by TCP/IP protocol.

21. A computer program as recited in claim 19, wherein said performance parameters comprises the target server response time, the transmit and receive pre-delay, total bytes transmitted/received, total transmit/receive delay, total time and the Request/Response header object.

22. A computer program as recited in claim 15, wherein said proxy server is essentially transparent to the network.

23. A computer program as recited in claim 15, wherein said transferring comprises transferring the selected application services between said proxy ports and assigned standard network ports governed by TCP/IP.

24. A computer program as recited in claim 23, wherein said step of transferring comprises transferring the selected application services between proxy ports and other network ports via bandwidth and latency control.

25. A computer program as recited in claim 24, wherein the network administrator access comprises:
bandwidth and latency adjustment of the selected application services
proxy and network port selection;
performance parameter selection;
proxy server module program changes; and
statistical results.

26. A computer program as recited in claim 25, wherein the network administrator is provided access at said client workstation or from a remote terminal connected to the network.

27. A computer program as recited in claim 15, wherein said WAN node is a network server.

28. A computer program as recited in claim 15, wherein said WAN node is an Internet Web server.
